(19) United States
(12) Patent Application Publication
(10) Pub. No.: US 2022/0343239 A1
(43) Pub. Date: Oct. 27, 2022

(54) FRIED FOOD DISPLAY MANAGEMENT APPARATUS AND FRIED FOOD DISPLAY MANAGEMENT METHOD

(71) Applicant: J-OIL MILLS, Inc., Tokyo (JP)

(72) Inventors: Takeshi SUZUKI, Tokyo (JP); Masami INOUE, Tokyo (JP); Kazuhiko HAKAMADA, Tokyo (JP); Shinsuke KOZONO, Tokyo (JP); Kenichi WATANABE, Tokyo (JP)

(21) Appl. No.: 17/760,789

(22) PCT Filed: Oct. 23, 2020
(86) PCT No.: PCT/JP2020/039835

§ 371 Date: Mar. 16, 2022

(30) Foreign Application Priority Data
Nov. 6, 2019 (JP) 2019-201760

(51) Int. Cl. G06Q 10/06; G06Q 10/08; G06Q 50/12; G06V 20/68; G06V 20/52

(52) U.S. Cl. CPC G06Q 10/06311; G06Q 10/06315; G06Q 10/087; G06Q 50/12; G06V 20/68; G06V 20/52

(57) ABSTRACT

A fried food display management apparatus 60 comprises: a first recognition unit 61 configured to recognize quantities of fried foods 19 according to type displayed in a display case 40 in a shop 32; a cooking schedule formulation unit 62 configured to, based on the quantities of the fried foods 19 according to type as recognized by the first recognition unit 61, formulate a cooking schedule for the types and quantities of fried foods 19 to be cooked in frying oil 17 in a fryer 14 installed in the shop 32; and a reporting unit 63 configured to report information relating to the cooking schedule in a display 25 provided in the shop 32.

### TECHNICAL FIELD

The present invention relates to a fried food display management apparatus and a fried food display management method for managing the displayed state of fried foods cooked and sold in a shop.

### BACKGROUND ART

In recent years, in convenience stores and other shops, fried foods fried in a fryer installed in the shop are sometimes displayed in a display section and sold to customers.

As such, when food cooked in the shop is sold, the profit of the shop can be improved by rationally setting a cooking schedule of the shop. The method described in Patent Document 1 is known as an example of such a schedule setting method.

Specifically, Patent Document 1 discloses a cooking management device for times when fried food is cooked using cooking equipment installed in a shop and the food is served to customers. This cooking management device generates a rational cooking schedule based on usage time (cooking time) of the cooking equipment and a standard lead time, which are different for each cooked product, for orders from a plurality of customers.

According to the cooking management device described in Patent Document 1, cooking is carried out according to the cooking schedule so that a serving time difference, which is a time from the ordering time point to the serving time point for each cooked product, is within a permissible value. Accordingly, it has become possible to improve the profits of shops by improving customer satisfaction.

### PRIOR ART DOCUMENTS

### Patent Documents

[Patent Document 1] Japanese Laid-Open Patent Application No. 2017-174294

### DISCLOSURE OF THE INVENTION

### Problems the Invention is Intended to Solve

Unlike cooking food at a restaurant, cooking of fried food at a convenience store or the like is rarely performed after receiving a customer's order. Therefore, in order to comply with the diverse tastes of customers and increase sales of fried foods, it is necessary to cook the fried foods purchased by customers in advance without any stockout or shortage and display the fried foods in a display section.

By contrast, in the cooking management device of Patent Document 1, a cooking schedule is first generated after orders from customers are received, the purpose of the cooking schedule being to keep serving time differences, which are times from the ordering time point to the serving time point for individual cooked products, within permissible values.

Therefore, problems have been presented in that cooked products that must be displayed in advance, such as fried foods in a convenience store or the like, cannot be cooked based on a cooking schedule formulated by the cooking management device of Patent Document 1, and it is not possible to set up an appropriate display that could improve sales, as shall be apparent.

An object of the present invention is to provide a fried food display management apparatus and a fried food display management method that make it possible for fried foods cooked in a shop to be appropriately displayed in a display section.

### Means for Solving the Aforementioned Problems

A fried food display management apparatus of the present invention comprises:

a first recognition unit configured to recognize quantities according to type of fried foods displayed in a display section in a shop;

a cooking schedule formulation unit configured to, based on the quantities of the fried foods according to type as recognized by the first recognition unit, formulate a cooking schedule for the types and quantities of fried food to be cooked in frying oil in a fryer installed in the shop; and

a reporting unit configured to report information relating to the cooking schedule in a display provided in the shop.

According to the present invention, a cooking schedule for the types and quantities of the fried foods to be cooked in the frying oil is formulated based on the recognition of the quantities of the fried foods according to type displayed in the display section. Therefore, due to cooking being performed in accordance with the formulated cooking schedule, fried foods having different cooking times according to type can be appropriately displayed in the display section without stockouts, shortages, overproduction, or other issues.

Preferably, in the fried food display management apparatus of the present invention,

the cooking schedule formulation unit configured to formulate the cooking schedule based on the quantity of the fried foods according to type as recognized by the first recognition unit, and at least one of the following: attributes of the shop, information relating to events that affect sales of the fried foods in the shop, future predicted sales predicted based on past sales performance of the fried foods according to type, the cooking times of the fried foods according to type, the present date and time, the degree of deterioration of the frying oil, and weather information.

According to this configuration, the cooking schedule is formulated with consideration not only for the quantities of the fried foods according to type displayed in the display case, but also for shop attributes, events, and other sales environment factors. Specifically, a cooking schedule is formulated which is adapted to sales environment factors that affect the sales of the fried foods.

As a result, the formulated cooking schedule takes consideration not only of the fried foods being displayed in the display case but also of sales environment factors, and it is possible to formulate an appropriate cooking schedule that flexibly corresponds to the future sales of the fried foods in the display case. Accordingly, the display of fried foods in the display case can be tailored as appropriate.

Preferably, the fried food display management apparatus of the present invention further comprises:

a second recognition unit configured to recognize stocking and removing of fried foods in and from the display section; and

a disposal information creation unit configured to determine disposal time points for the fried foods being displayed in the display section based on information on the stocking and removing recognized by the second recognition unit, and cause the reporting unit to report information relating to the disposal time point.

According to this configuration, based on the stocking and removing of the fried foods in and from the display section, the disposal time points for the fried foods can be automatically recognized and these disposal time points can be reported appropriately. As a result, disposal of the fried foods in the display section can be managed appropriately.

Preferably, the fried food display management apparatus of the present invention

further comprises a first display section state setting unit configured to set a display section state recommended according to the types of the fried foods in the display section based on at least one of the following: the disposal time points for the fried foods being displayed in the display section, sales priority levels set for the types of the fried foods, the cooking schedule formulated by the cooking schedule formulation unit, information relating to events that affect the sales of the fried foods in the shop, future predicted sales predicted based on past sales performance of the fried foods according to type, and the degree of deterioration of the frying oil; and causes the reporting unit to report the set and recommended display section state.

According to this configuration, a display section state recommended for the display section is set based on, inter alia, the disposal time points and sales priority levels of the fried foods being displayed in the display section, and the recommended display section state is reported.

Thus, by putting the fried foods in the display section into the recommended display section state, it is possible to, inter alia, prevent waste in fried food disposal, etc., make sales consistent with the cooking schedule and the deterioration of the frying oil, maintain quality, improve cooking efficiency, increase sales by adjusting the number of products to be consistent with sales predictions based on events, etc., and contribute to the management of the shop.

Preferably, the fried food display management apparatus of the present invention further comprises:

a third recognition unit configured to recognize the display section state of the fried foods in the display section; and

a second display section state setting unit configured to set a display section state recommended for the fried foods in the display section based on the display section state of the fried foods at the given time in the display section according to the third recognition unit and the disposal time points of the fried foods being displayed in the display section, and cause the reporting unit to report the set and recommended display section state.

According to this configuration, a display section state recommended for the fried foods in the display section is set based on the display section state of the fried foods at the given time in the display section and the disposal time points and of the fried foods being displayed in the display section, and the display section state is reported.

Due to this configuration, when fried foods having an imminent disposal time point are already in a prominent location in the display section state at the given time, it is possible to change the impression given by the display section state and to overcome a lull in the sales of fried foods having an approaching disposal time point by, inter alia, changing to other prominent locations in the recommended display section state, or switching locations in the recommended display section state when there are multiple fried foods having an approaching disposal time point in the display section state at the given time and all are already in prominent locations in the display section.

A fried food display management method of the present invention comprises:

a recognition step of recognizing quantities according to types of fried foods displayed in a display section in a shop;

a cooking schedule formulation step of, based on the quantities of the fried foods according to type as recognized in the recognition step, formulating a cooking schedule for the types and quantities of fried foods to be cooked in frying oil in a fryer; and

a reporting step of reporting information relating to the formulated cooking schedule in a display provided in a shop.

According to the present invention, a cooking schedule for the type and quantity of the fried food to be cooked in the frying oil is formulated based on the recognition of the quantity of the fried food according to type displayed in the display section. Therefore, fried foods having different cooking times according to type can be appropriately displayed in the display section without stockouts, shortages, overproduction, or other troubles.

### BRIEF DESCRIPTION OF THE DRAWINGS

FIG. 1 shows a kitchen where fried foods to be sold to customers are cooked;

FIG. 2 shows a display case in a shop;

FIG. 3 is a schematic view of a network system including a plurality of shops and a headquarters;

FIG. 4 is a function block diagram of a fried food display management apparatus; and

FIG. 5 is a flowchart of a fried food display management method.

### BEST MODE FOR CARRYING OUT THE INVENTION

A preferred embodiment of the present invention is described in detail below. In the following description, like reference symbols are used for substantially the same or equivalent elements and components. In addition, for pairs or groups elements that have the same configuration, reference symbols are used that have the same numbers but different letters of the alphabet (e.g., button switches 23a, 23b, . . . , 23i). Furthermore, when elements constituting a pair or group are collectively referred to, the alphabet letters are omitted and a reference symbol of only the number is used (e.g., button switches 23).

(Kitchen)

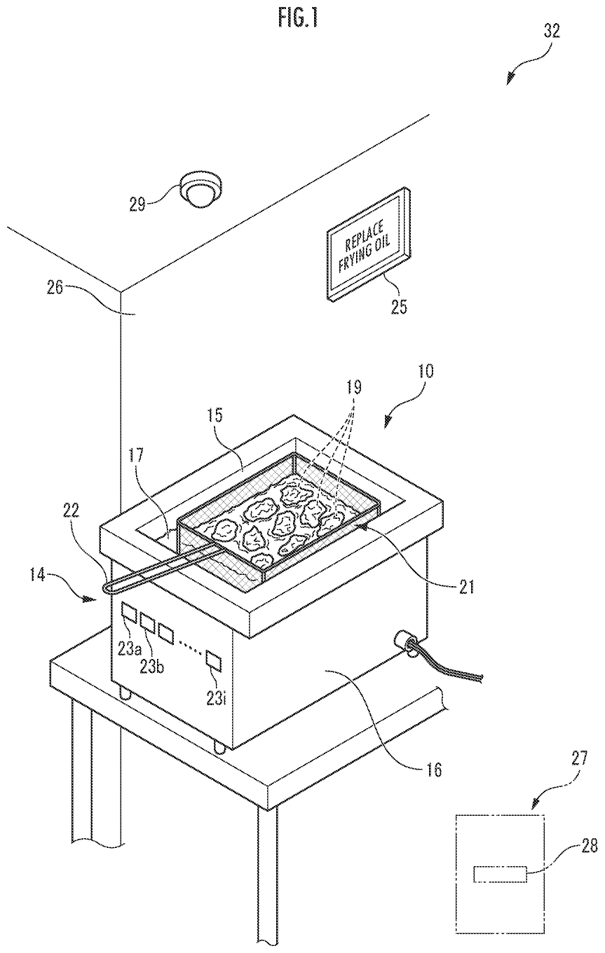

FIG. 1 shows a kitchen 10 where fried foods 19 to be sold to customers are cooked. The kitchen 10 is provided in a convenience store, a supermarket, or another shop 32, and an electric fryer 14 is installed in the kitchen.

The kitchen 10 is provided in the facility 32, and an electric fryer 14 is installed in the kitchen. The fryer 14 has an oil tank 15 and a housing 16 that accommodates the oil tank 15. An upper side of the oil tank 15 is opened, and the oil tank 15 is provided in an upper part of the housing 16. Frying oil 17 is filled in the oil tank 15 until reaching a predetermined height. The fried foods 19 are placed in a frying basket 21 that has a handle 22, and are then immersed in the frying oil 17, which is heated, in the oil tank 15.

The types of fried foods 19 (e.g., (fried) chicken, potatoes, and croquettes) that are placed together in the frying basket 21 and immersed together in the frying oil 17 are usually often the same. Specifically, the immersion time (frying time) in the frying oil 17 is different for each type of fried foods 19, and since the different kinds of fried foods 19 have different immersion times, it is difficult to fry different foods at the same time.

A plurality of button switches 23a, 23b, . . . , 23i are provided in an outer surface of the housing 16 according to the types of fried foods 19, and when a button switch corresponding to a fried food 19 is pressed, after an immersion time suited to the fried food 19 has elapsed, a buzzer sound is emitted from the fryer 14 for a regular time and the frying basket 21 automatically rises from the oil tank 15. Alternatively, a buzzer sound is outputted from a speaker (not shown) of the fryer 14, or a display 25 in a wall 26 displays that frying has ended.

A switch for adjusting the temperature of the frying oil 17 may be provided for each type of fried food 19. However, because the temperature of the frying oil 17 often does not change appreciably depending on the type of the fried food 19, it is sufficient if the temperature can be set to a specific temperature.

A camera 29 is attached to the ceiling or the wall 26. The camera 29, which may be either a video camera or a still camera, captures the state in the oil tank 15 of the fryer 14 continuously or at regular time intervals. The type, quantity, etc., of fried foods 19 in the frying basket 21 can be detected from an output image of the camera 29.

An information processing device 27 is set up inside or outside the shop 32 (the drawing shows an example in which the device 27 is set up inside the shop 32), and shop business software 28 is installed on the device 27. The information processing device 27 sends data to, and receives data from, the display 25 and the camera 29. The type, quantity, etc., of fried foods 19 in the frying basket 21 can be detected from captured image data sent from the camera 29 to the information processing device 27. Furthermore, the time over which each type of fried food 19 is fried can also be detected because the loading and removing of the frying basket 21 into and out of the oil tank 15 can be detected from the image captured by the camera 29.

When frying is performed using the frying oil 17, first, a cook (not shown), who is a shop worker assigned to cooking, puts the fried food 19 into the frying basket 21, and then hangs the frying basket 21 on an upper end of a peripheral wall of the oil tank 15, or submerges the frying basket 21 until the bottom of the frying basket 21 touches the bottom of the oil tank 15, so that all of the fried foods 19 in the frying basket 21 are immersed in the frying oil 17. The cook then presses one button switch 23 corresponding to the type of fried food 19 to be fried in the given instance.

The fryer 14 evaluates which button switch 23 has been operated by the cook, and when the frying time associated with the operated button switch 23 elapses, a buzzer sound is outputted from the speaker (not shown) of the fryer 14 as previously described.

It is also possible to connect the fryer 14 and the information processing device 27 in a wired or wireless scheme such that data can be sent and received, and to report the end of the frying time of the fried food 19 in the fryer 14 to the display 25. Furthermore, when a degree of deterioration of the frying oil 17 is measured based on acid value, viscosity, etc., and the degree of deterioration reaches a first threshold value, the display 25 may read, for example, “Replace frying oil.”

Furthermore, when the degree of deterioration of the frying oil 17 reaches a second threshold value (that is greater than the first threshold value), the information processing device 27 may, from that point onward, continuously display on the display 25 that the degree of deterioration of the frying oil 17 has reached the second threshold value. Furthermore, the operation of the button switch 23 of the fryer 14 may be disabled so as to forcibly prohibit the use of the fryer 14. The display on the display 25 is fixed in a position that can be visually confirmed by a shop worker other than a person assigned to cooking; e.g., a supervisor.

As a result, the cook becomes aware that the current instance of frying has ended and pulls up the frying basket 21 to take out the fried food 19 from the oil tank 15. The frying basket 21 can be raised and lowered automatically by providing a drive mechanism.

(Display Section)

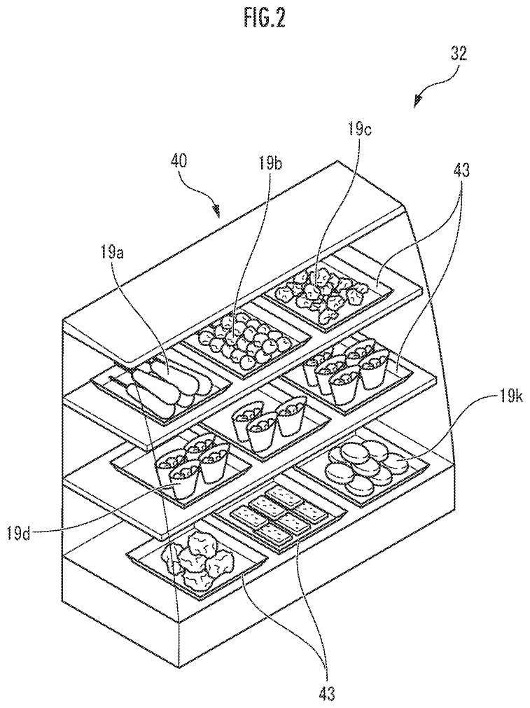

FIG. 2 shows a display case 40 in the shop 32. In the display case 40 serving as a display section, a plurality of fried foods 19a, 19b, . . . , 19k are displayed vertically and horizontally. The fried foods 19 are placed on the same tray 43 for each type and are displayed in the display case 40. If the fried foods 19 in the display case 40 are moved to another location together with the tray 43, the state in which the fried foods 19 are displayed in the display case 40, specific to type, will be changed.

Generally, fried foods 19 of a type that are desired to be sold in greater quantity in the shop 32 are displayed in a location that attracts customers' attention in the display case 40. Generally, in the display case 40, the central section rather than the peripheral section and the upper section rather than the lower section attract customers' attention.

Although not shown in FIG. 2, a camera that monitors the display section state of the display case 40 is installed. The camera can be mounted on the ceiling or wall 26, as is the camera 29 in FIG. 1. However, the fried foods 19 displayed in the display case 40 must be arranged in positions where the display section state can be visually recognized.

In order to monitor the display section state of the display case 40, it is possible, inter alia, for one small camera to be mounted on the lower surface of each shelf of the display case 40, or, in some cases for one to be installed directly above each tray 43. Images captured by the small cameras are sent to the information processing device 27, and are synthesized, analyses, or otherwise processed by the shop business software 28.

(Network)

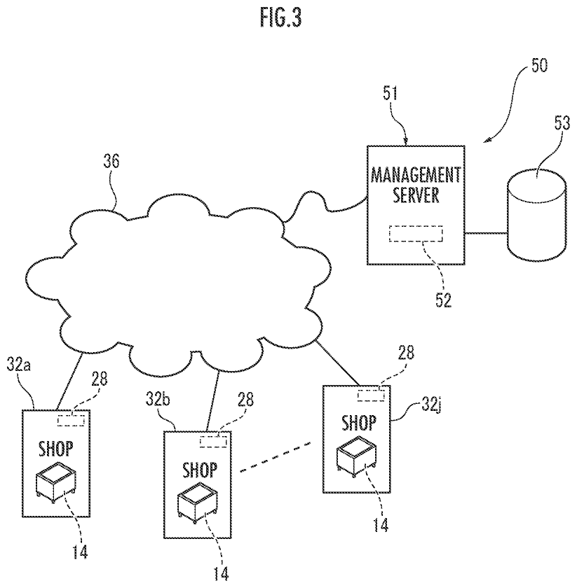

FIG. 3 is a schematic drawing of a network system including a plurality of shops 32a, 32b, . . . , 32j and headquarters 50. The plurality of shops 32a, 32b, . . . , 32j make up, for example, a convenience store chain or a supermarket chain, and oversight of the shops is given to headquarters 50 serving as an oversight department.

The shops 32 are each equipped with a fryer 14 and an information processing device 27. The shop business software 28 is installed on the information processing device 27.

The management server 51 is set up in the headquarters 50. The management server 51 and the information processing devices 27 (FIG. 1) of the shops 32 send and receive data via the internet 36.

In the headquarters 50, a database 53 is connected to the management server 51. The database 53 also serves as a storage device for the management server 51, and information other than that in the database can also be stored as appropriate.

Headquarters business software 52 executes sales management (e.g., POS systems), etc. The management server 51 has a well-known structure that includes all basic hardware (e.g., CPU, ROM, RAM, interface, etc.) as resources utilized by a variety of computer software.

The headquarters business software 52 can include business performed individually by each shop 32 and business processes performed on behalf of each shop 32. Such proxy business processes can include, for example, management of a single or a plurality of fryers 14 in the same shop 32, and display management of a single or a plurality of display cases 40.

(Fried Food Display Management Apparatus)

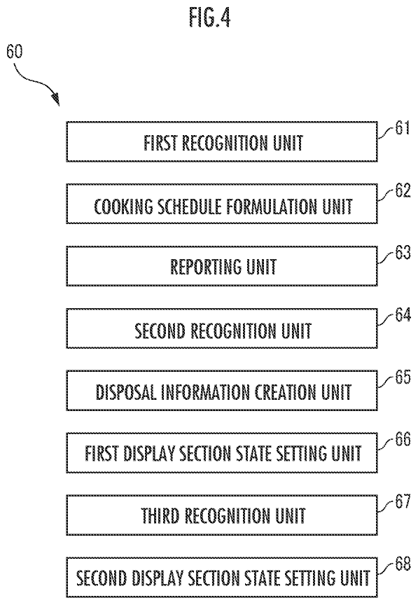

FIG. 4 is a function block diagram of a fried food display management apparatus 60. All of the fried food display management apparatus 60 is implemented in the shop business software 28 or the headquarters business software 52, or the implementation of the apparatus is distributed between the shop business software 28 and the headquarters business software 52.

The fried food display management apparatus 60 comprises a first recognition unit 61, a cooking schedule formulation unit 62, a reporting unit 63, a second recognition unit 64, a disposal information creation unit 65, a first display section state setting unit 66, a third recognition unit 67, and a second display section state setting unit 68.

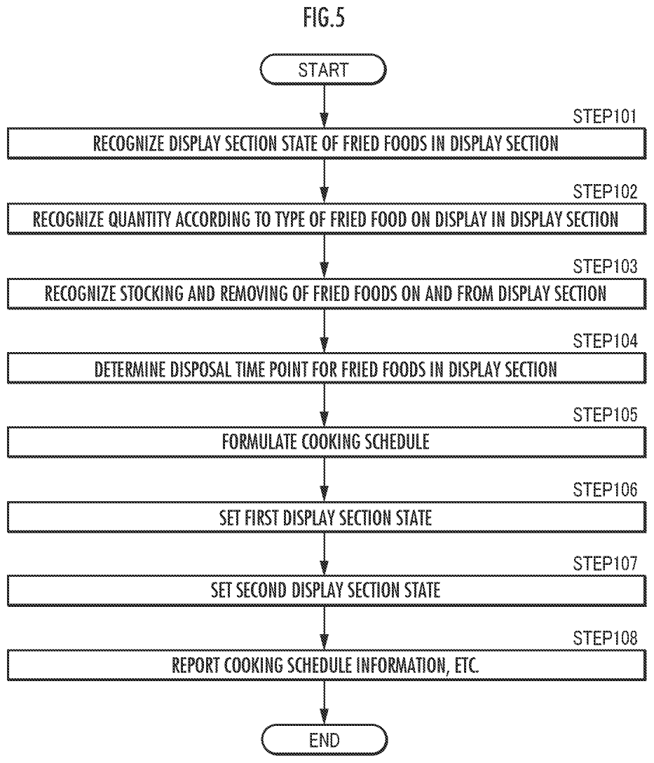

The first recognition unit 61, the second recognition unit 64, and the third recognition unit 67 are not separate elements, and one of these units can also serve as one or two of the other. Details of the individual functional blocks shall be described in the flowchart of FIG. 5 below.

FIG. 5 is a flowchart of a fried food display management method. The fried food display management method of FIG. 5 is executed with the activation of one of the corresponding programs among the plurality of programs included in the shop business software 28. The activation is performed by a predetermined trigger. The trigger includes at least one factor such as the passage of a certain time, the stocking and removing of the fried food 19 in and from the display case 40, the entry and exit of a customer, and the completion of the customer's payment at the cash register.

In STEP 101, the third recognition unit 67 recognizes the display section state of the fried foods 19 in the display case 40.

The recognition by the third recognition unit 67 of the display section state of the fried foods 19 in the display case 40 can be performed based on an image captured by, for example, a camera mounted on the ceiling or the wall 26 at a location where the camera can monitor the display case 40 from the outside, and furthermore, small cameras installed on the underside of each shelf or directly above each tray 43 in the previously described display case 40, in order to monitor the display case 40.

As a recognition method other than utilizing cameras, an assigned shop worker managing the display case 40 can also recognize the display section state based on data inputted manually to an input/output interface provided in the display case 40 or to a portable tablet. Furthermore, it is also possible to detect the quantity of fried foods 19 contained in each tray 43 from the weight of each tray 43 using a pressure sensor, a weight sensor, etc.

For example, the input/output interface or the tablet is provided with an operation unit by which the assigned shop worker divides the inside of the display case 40 into a plurality of sections and inputs the stocking and removing of the fried foods 19 for each section. In this case, one section can be assigned to one tray 43 or a plurality of horizontally continuous trays 43.

Generally, one type of fried food 19 is stocked on the same tray 43. In addition, the same type of fried food 19 may be stocked on a plurality of horizontally continuous trays 43. Therefore, if the stocking and removing of the fried foods 19 on and from each tray 43 is known, in the display case 40, how many and which type of fried food 19 is displayed in each section of the display case 40 is ascertained, and the display section state of the display case 40 at the given time is ascertained.

In STEP 102, the first recognition unit 61 recognizes the quantity according to type of the fried foods 19 displayed in the display case 40.

The recognition by the first recognition unit 61 of the quantity according to type of the fried foods 19 applies to the entire display case 40, and it is therefore not necessary to recognize which type is placed in which location of the display case 40.

In STEP 101, the third recognition unit 67 monitors the stocking and removing of the types and quantities of fried foods in and from each of the sections of the display case 40, and if display section states of the display case 40 at individual points in time are recognized, the quantity according to type can be recognized for the fried foods 19 in the entire case, as is obvious. Therefore, the recognition process of STEP 102 can be performed together with STEP 101 by the third recognition unit 67, rather than by the first recognition unit 61.

In STEP 103, the second recognition unit 64 recognizes the stocking and removing of the fried foods 19 in and from the display case 40.

In STEP 101, the third recognition unit 67 monitors the stocking and removing of the types and quantities of fried foods in and from each of the sections of the display case 40, and if display section states of the display case 40 at individual points in time are recognized, the recognition process of STEP 10 can be performed together with STEP 101 by the third recognition unit 67, rather than by the second recognition unit 64.

In STEP 104, the disposal information creation unit 65 determines a time point to dispose of the fried foods 19 being displayed in the display case 40, based on the stocking and removing recognized by the second recognition unit 64.

Using the time point at which the fried foods 19 finish cooking in the fryer 14 as a starting time point, the disposal time point can be calculated as a time point obtained by adding, for example, a predetermined time limit from the starting time point. Instead of the time point at which the fried foods finish cooking in the fryer 14, the time point at which the fried foods 19 are stocked in the display case 40 can also be selected as the starting time point.

The odor and state of moisture of the fried food 19 changes with the passage of time. Therefore, the disposal time point of the fried foods 19 can be detected using an odor sensor, a moisture-sensitive sensor, etc., instead of using a built-in clock that detects the date and time.

The time limit can also be set for each type of fried food 19. When fried food 19 is removed from the display case 40 within the time limit, the fried food 19 is recognized to have been sold to a customer and the tracking of stocking and removal is ended.

The fried food 19 once taken out from the tray 43 may be returned to the tray 43 again due to a mistake in handling by the shop worker or a mistake in speaking by the customer. In this case, the shop worker can manually perform a process of cancelation for the returned fried food 19 using a tablet or another user interface. As a result, the starting time point of the returned fried food 19 is not the starting time point set for the newly cooked fried food 19, but is returned to the starting time point that had been set for the fried food 19, at which the fried food 19 was taken out from the tray 43 and the tracking of the stocking and removing was completed. To supplement this feature, the starting time point for the fried food 19 is not deleted immediately after the tracking is completed, and remains in memory without being deleted; therefore, for a predetermined time, the starting time point can be returned to the starting time point that preceded the removal of the fried food.

In STEP 105, based on the quantity of fried food 19 according to type as recognized by the first recognition unit 61, the cooking schedule formulation unit 62 formulates a cooking schedule for the type and quantity of fried food 19 cooked in the frying oil 17 in the fryer 14 installed in the shop 32.

The cooking schedule formulated by the cooking schedule formulation unit 62 is formulated based on, for example, at least one of the following cooking policies (a1)-(a5).

(a1) In the display case 40, all types of fried foods 19 served by the shop 32 are displayed in at least the minimum display quantity according to type. The minimum display quantity may be set for each type of fried food 19, or may be set uniformly regardless of the type.

(a2) For fried food 19 of a type having a long frying time, frying is started when the quantity displayed in the display case 40 is in greater excess of the minimum display quantity, as compared with fried food 19 of a type having a short frying time.

(a3) The fried foods 19 are prevented from being overproduced, left unsold until the disposal time point, and disposed of.

(a4) An aesthetic display section state is maintained in the display case 40.

(a5) When there are many customers entering and exiting, the shop worker can focus on cash register work and product replenishment work rather than cooking.

Specifically, the cooking schedule formulation unit 62 uses the quantities of fried foods 19 according to type in the display case 40 as recognized by the first recognition unit 61 as main cooking parameters, further adds ancillary cooking parameters, and formulates a cooking schedule based on values recognized for the plurality of cooking parameters.

For ancillary cooking parameters, at least one of the following is selected, for example: the attributes of the shop 32, information relating to events that affect sales of the fried foods 19 in the shop 32, information on future predicted sales predicted based on past sales performance of the fried foods 19 according to type, the cooking times of the fried foods 19 according to type, the present date and time, the degree of deterioration of the frying oil 17, and weather information.

The attributes of the shop 32 include the environment where the shop 32 is located and the scale of the shop 32 (e.g., the quantity of shop workers and the shop area). Furthermore, as a supplement, the environment where the shop 32 is located can be divided into, for example, the presence or absence of competing shops in the same commercial area (e.g., shops belonging to a chain series different from the chain series to which the given shop belongs), an office district, a student district, a resort area, the area in front of a transport station (where customers come to the shop on foot), and a suburb (where customers come to the shop by car). It is possible to investigate the number of people, gender, and age for individual time bands of pedestrian traffic in front of the shop 32, and formulate a cooking schedule for the fried foods 19 according to type that reflects the investigation results. In addition, the chicken variety of fried food 19 generally sells well in student districts.

Events include, for example, road construction, construction work, athletic meets (e.g., school athletic meets and sports days such as baseball and soccer), fireworks festivals, entrance ceremonies, coming-of-age ceremonies, etc. At fireworks festivals, the take-out of the deep-fried and potato varieties of fried foods 19 tends to increase after the evening. Therefore, after the evening, a cooking schedule is formulated to increase the cooked quantities of the deep-fried and potato varieties of fried foods 19. Events can include sudden accidents and obstacles that are a negative factor in the sales of fried food 19.

Past sales performance includes, for example, sales performance for the last week, the same day of the week last week, the same month last year, and the previous event day. The predicted sales volume in the future can be calculated by using, inter alia, the remaining time from the current date and time to the closing time of the given day, the weather forecast, and the current ambient temperature as prediction parameters. For example, on a rainy day with an ambient temperature of 18° C. or less, sales of the cream croquette variety of fried food 19 will increase. Therefore, on such a day, a cooking schedule is formulated to increase the cooked quantity of cream croquette fried foods 19.

From the given date and time of the ancillary parameters, for example, it is possible to formulate a cooking schedule such as the following. If the given day is a weekday, sales will be concentrated on boxed lunches rather than fried foods 19. Therefore, the quantities of fried foods 19 cooked are reduced accordingly. If the given day is during a summer vacation period, the sales of fried food 19 that is chicken will drop. Therefore, the quantity of chicken fried food 19 cooked is less than before the summer vacation. If the given day is during a weekend, sales of fried foods 19 that are croquettes will drop. Therefore, the quantity of croquette fried foods 19 cooked is less than on weekdays.

The degree of deterioration of the frying oil 17 is a factor that determines the point at which the frying oil 17 is disposed of (the timing at which the frying oil 17 in the oil tank 15 is replaced). The frying oil 17 in the oil tank 15 deteriorates as the fried quantity of fried foods 19 increases. Therefore, before the degree of deterioration of the frying oil 17 in the oil tank 15 reaches a predetermined upper limit, the frying oil must be disposed of and replaced with new frying oil 17. Because the replacement work takes a predetermined time, it is desirable to avoid overlapping replacement work periods during busy periods in the shop 32.

Therefore, it is desirable that the work of replacing the frying oil 17 in the oil tank 15 is completed before a busy period, and that the frying oil 17 is not disposed of too early and is not wasted. As an appropriate measure, for example, when the degree of deterioration of the frying oil 17 in the oil tank 15 is approaching the upper limit, a cooking schedule that is early and generous in allowing for the cooking of the fried foods 19 is formulated so that the frying oil 17 is fully used before being disposed of. It is thereby possible to carry out replacement work before a busy period and conserve the frying oil 17.

In STEP 106, the first display section state setting unit 66 sets a recommended first display section state based on a first display parameter.

For the first display parameter, at least one of the following can be selected: the disposal time points of individual fried foods 19 being displayed in the display case 40, sales priority levels set for the types of the fried foods 19, the cooking schedule formulated by the cooking schedule formulation unit 62, information relating to events that affect sales of the fried foods 19 in the shop 32, future predicted sales predicted based on past sales performance of the fried foods 19 according to type, and the degree of deterioration of the frying oil.

Types of fried foods 19 having high sales priority levels may be set by the headquarters 50 as a sales promotion measure. The headquarters 50 may set a new type of fried food 19 as a promotional product. In addition, a set of a specific type of fried food 19 and a specific drink may be used in a sales promotion campaign.

The setting of the recommended first display section state in STEP 106 is carried out without referring to the display section state in the display case 40 at the given time. The type of fried food 19 that is to be sold out as soon as possible or sold in greater quantity is displayed in the display case 40 in a location that attracts customers' attention. Alternatively, depending on the type of fried food 19, the food may be small and inconspicuous (*1), or conversely, the food may, due to bright color, be sufficiently prominent even if the food is displayed in the peripheral section of the display case 40.

With these factors taken into consideration, the first display section state setting unit 66 sets the first display section state based on a display policy. As the policy for setting the first display section state, for example, (b1) the display case 40 as a whole receives maximum attention from customers, or (b2) the fried foods 19 may be in a display section state at which sales reach maximum.

As the policy for setting the first display section state based on a customer segment that differs for each shop 32 and for each date and time of the given time, it is also possible to select a display section state that appeals to women, children, singles, or the elderly.

In STEP 107, the second display section state setting unit 68 sets a second display section state recommended for the fried foods 19 in the display case 40 based on display section state at the given time for the fried foods 19 in the display case 40 according to the recognition performed by the third recognition unit 67 in STEP 101, and the disposal time point according to the determination performed by the disposal information creation unit 65 in STEP 104.

The difference between the first display section state of STEP 106 and the second display section state of STEP 107 is that the first display section state is set without considering the display section state at the given time, whereas the second display section state is set in consideration of the display section state at the given time.

Because the second display section state is set in consideration of the display section state at the given time, the reporting in the next STEP 108 can be stopped when, inter alia, changing the display would require too much effort or would not lead to an increase in sales, even if the second display section state is the same as or somewhat different from the display section state at the given time.

In STEP 108, the reporting unit 63 issues a report. The report includes information relating to the disposal time point determined in STEP 104, the cooking schedule formulated in STEP 105, the first display section state set in STEP 106, and the second display section state set in STEP 107.

The reporting unit 63 reports the recommended display section state to the shop worker using the display 25, etc. The reporting unit 63 can also instruct the shop worker of the recommended display section state by using voice.

Possible specific examples of the content of the report issued by the reporting unit 63 include the following. The response of the shop worker who received such a report is described after the symbol “→”.

(c1) “Quantity of fried foods 19 in display case 40 is low.”

→Cooks fried foods 19.

(c2) “Certain amount of time has passed since fried foods 19 in display case 40 were cooked.”

→Changes display section state of fried foods 19, disposes of corresponding fried foods 19, cooks new fried foods 19, etc.

(c3) “Event in neighborhood today, expected sales are: ______ pieces of XX chicken, YY . . . ”

→Cooks corresponding type of fried foods 19.

(c4) “XX match in neighborhood today, but due to bad weather, expected sales are: ______ pieces of XX chicken, YY . . . ”

→Cook corresponding type of fried foods 19.

(c5) “As summer vacation ends next week, sales trends will change.”

→Changes cooking schedule from summer vacation period to period after summer vacation.

The effects of the embodiment are summarized as follows.

(U1) A cooking schedule for the types and quantities of the fried foods 19 to be cooked in the frying oil 17 is formulated based on the recognition of the quantities of the fried foods 19 according to type displayed in the display case 40. As a result, fried foods 19 having different cooking times according to type can be appropriately displayed in the display case 40 without stockouts, shortages, overproduction, or other troubles (STEP 102, 105).

(U2) The cooking schedule is formulated with consideration not only for the quantities of the fried foods 19 according to type displayed in the display case 40, but also for shop attributes, events, and other sales environment factors (e.g., the ancillary cooking parameters mentioned in STEP 105).

As a result, the formulated cooking schedule takes consideration not only of the fried foods 19 being displayed in the display case 40 but also of sales environment factors, and it is possible to formulate an appropriate cooking schedule that flexibly corresponds to the future sales of the fried foods 19 in the display case 40. Accordingly, the display of fried foods in the display case 40 can be made appropriate.

(U3) Based on the stocking and removing of the fried foods 19 in and from the display case 40, the disposal time points for the fried foods 19 can be automatically recognized and can be reported appropriately (STEP 103, 108). As a result, disposal of the fried foods in the display section can be managed appropriately.

(U4) A display section state recommended for the display case 40 is set based on, inter alia, the disposal time points and sales priority levels of the fried foods 19 being displayed in the display case 40 (*2), and the recommended display section state is reported as a first display section state (STEP 106, 108).

Thus, by putting the fried foods in the display section into the recommended display section state, it is possible to, inter alia, prevent waste in fried food disposal, etc., make sales consistent with the cooking schedule and the deterioration of the frying oil, maintain quality, improve cooking efficiency, increase sales by adjusting the number of products to be consistent with sales predictions based on events, etc., and contribute to the management of the shop.

(U5) A display section state recommended for the fried foods in the display section is set based on the display section state of the fried foods at the given time in the display case 40 and the disposal time points and of the fried foods 19 being displayed in the display case 40, and the display section state is reported (STEP 107, 108).

Due to this configuration, even if fried foods 19 having an approaching disposal time point are already in a prominent location in the display section state at the given time, it is possible to change the impression that the display section state gives to customers and to promote sales of fried foods 19 having an approaching disposal time point.

(Modifications)

In the embodiment, all of the elements of the fried food display management apparatus 60 are implemented in the shop business software 28, but some elements can be implemented in the headquarters business software 52 of the management server 51. In such instances, the elements implemented in the headquarters business software 52 carry out a process for each store. For example, the cooking schedule formulation unit 62 and/or the disposal information creation unit 65 can be selected as elements provided in the headquarters business software 52.

When the cooking schedule formulation unit 62 and/or the disposal information creation unit 65 are executed by the headquarters business software 52, the headquarters business software 52 can compare the cooking schedules and display section states of the target shop 32 and other shops. In addition, the headquarters business software 52 can also find a shop 32 having a set cooking schedule and display section state for which the sales amount is high for the number of shop workers by making comparisons with the average cooking schedule and display section state of the entire chain of shops 32, and can use that shop 32 as a model shop.

The headquarters business software 52 can compare the cooking schedules and display section states of the target shop 32 and other shops. The headquarters business software 52 can also compare the cooking schedule and display section state of the target shop 32 with the average cooking schedule and display section state and with the cooking schedule and display section state of a model shop, and can notify the target shop 32 of a plan to improve the cooking schedule and display section state of the target shop 32.

In the embodiment, the cooking schedule formulation unit 62 formulates a cooking schedule using attributes of the shop 32, events, etc., as ancillary cooking parameters. In the formulation of a cooking schedule, the relationship between a cooking schedule formulated based on at least one ancillary cooking parameter and maximum future sales in the shop 32 can be searched for by AI, machine learning, deep learning, etc.

In the embodiment, the first display section state setting unit 66 sets a first display section state recommended for the display case 40 based on first display parameters. For the first display parameters, the disposal time points and the types of the fried foods 19 being displayed in the display case 40 are searched for, and the setting of the first display section state, the sales priority levels, etc., are set for the searched types.

In the setting of the first display section state, a first display section state at which future sales reach a maximum in the shop 32 can be searched for by AI, machine learning, deep learning, etc., based on the relationship between display section states and at least one of the first display parameters.

In the embodiment, the second display section state setting unit 68 sets a second display section state recommended for the fried foods 19 in the display case 40 based on the display section state of the fried foods 19 in the display case 40 at the given time and the disposal time points according to the determination performed by the disposal information creation unit 65.

In the setting of the second display section state, a second display section state at which loss due to the disposal of fried foods 19 in the shop 32 will be minimal can be searched for by AI, machine learning, deep learning, etc., based on the relationship between the display section state at the given time and disposal time points, and it is possible to set a second display section state for which the second display section state of the search result is recommended.

### KEY TO SYMBOLS

14 Fryer

15 Oil tank

17 Frying oil

19 Fried food

25 Display

32 Shop

40 Display case (display section)

60 Fried food display management apparatus

61 First recognition unit

62 Cooking schedule formulation unit

63 Reporting unit

64 Second recognition unit

65 Disposal information creation unit

66 First display section state setting unit

67 Third recognition unit

68 Second display section state setting unit

1. A fried food display management apparatus comprising a processor and a memory having program code stored therein for execution by the processor,
wherein the processor executes the computer program code to:
recognize
quantities according to type of fried foods displayed in a display section in a shop;
based on the quantities of the fried foods according to type as recognized by the first recognition unit, formulate a cooking schedule for the types and quantities of fried foods to be cooked in frying oil in a fryer installed in the shop; and
report information relating to the cooking schedule in a reporting unit provided in the shop.

2. The fried food display management apparatus according to claim 1, wherein the cooking schedule formulation unit formulates the cooking schedule based on the quantity of the fried foods according to type as recognized by the first recognition unit, and at least one of the following: attributes of the shop, information relating to events that affect sales of the fried foods in the shop, future predicted sales predicted based on past sales performance of the fried foods according to type, the cooking times of the fried foods according to type, the present date and time, the degree of deterioration of the frying oil, and weather information.

3. The fried food display management apparatus according to claim 1, further comprising:
a second recognition unit configured to recognize stocking and removing of fried foods in and from the display section; and
a disposal information creation unit configured to determine disposal time points for the fried foods being displayed in the display section based on information on the stocking and removing recognized by the second recognition unit, and cause the reporting unit to report information relating to the disposal time point.

4. The fried food display management apparatus according to claim 1, further comprising a first display section state setting unit configured to set a display section state recommended according to the types of the fried foods in the display section based on at least one of the following: the disposal time points for the fried foods being displayed in the display section, sales priority levels set for the types of the fried foods, the cooking schedule formulated by the cooking schedule formulation unit, information relating to events that affect the sales of the fried foods in the shop, future predicted sales predicted based on past sales performance of the fried foods according to type, and the degree of deterioration of the frying oil; and cause the reporting unit to report the set and recommended display section state.

5. The fried food display management apparatus according to claim 1, further comprising:
a third recognition unit configured to recognize the display section state of the fried foods in the display section; and
a second display section state setting unit configured to set a display section state recommended for the fried foods in the display section based on the display section state of the fried foods at the given time in the display section according to the third recognition unit and the disposal time points of the fried foods being displayed in the display section, and cause the reporting unit to report the set and recommended display section state.

6. A fried food display management method comprising:
a recognition step of recognizing quantities according to types of fried foods displayed in a display section in a shop;
a cooking schedule formulation step of, based on the quantities of the fried foods according to type as recognized in the recognition step, formulating a cooking schedule for the types and quantities of fried foods to be cooked in frying oil in a fryer; and
a reporting step of reporting information relating to the formulated cooking schedule in a display provided in a shop.
